(19) United States
(12) Patent Application Publication
(10) Pub. No.: US 2017/0243238 A1
(43) Pub. Date: Aug. 24, 2017

(54) SYNTHETIC USER PROFILES

(71) Applicant: Ad Lightning, Inc., Seattle, WA (US)

(72) Inventors: Ryan Kosai, Seattle, WA (US); Michael Galgon, Seattle, WA (US)

(21) Appl. No.: 15/439,475

(22) Filed: Feb. 22, 2017

Related U.S. Application Data
(60) Provisional application No. 62/298,379, filed on Feb. 22, 2016.

(51) Int. Cl. G06Q 30/02; G06Q 10/06

(52) U.S. Cl. CPC G06Q 30/0204; G06Q 10/067

(57) ABSTRACT

Disclosed is a system and method for creating synthetic user profiles or “personas.” Embodiments are disclosed that initialize a browser (or other resource retrieval software) in accordance with a subject demographic. Various criteria may be simulated in accordance with various embodiments. The browser (or other software) visits a number of predetermined or pseudo-random sites on a wide area network, such as the Internet. The browser (or other software) accumulates user-specific data as it visits each of the sites. The browser (or other software) stores off the accumulated user-specific data in conjunction with a synthetic user profile.

### RELATED PATENTS

This application claims priority to and the benefit of co-pending U.S. Provisional Patent No. 62/298,379, filed on Feb. 22, 2016, entitled “Monitoring and Policing Online Advertisements,” the disclosure of which is hereby incorporated by reference for all purposes as if set forth here in its entirety.

### TECHNICAL FIELD

The disclosed subject matter pertains generally to the area of online communications, and more specifically to the area of data used in tracking the browsing habits of individuals.

### BACKGROUND INFORMATION

Web developers are constantly seeking new ways to improve the usability, effectiveness, and appropriateness of the websites they develop. Testing, monitoring, and policing the content served from a website is an ongoing effort. In addition, online technology enables targeted ads based on a visitor's browsing history.

Similarly, very many websites are configured to implement user-specific data for a website visitor. A web “cookie” is one specific example of user-specific data. Cookies are delivered to a visitor's browser software and are used as a simple tool to persist data between browsing sessions. User-specific data helps a website to tailor the experience for different visitors to the website. Cookies are but one of very many different types of user-specific data.

A technique for evaluating a website while accounting for user-specific data has eluded those skilled in the art, until now.

### SUMMARY OF EMBODIMENTS

Embodiments are directed to a tool for creating synthetic user profiles. Each synthetic user profile includes user-specific data that approximates the browsing behavior of a particular individual, type of individual, and/or target demographic.

### BRIEF DESCRIPTION OF THE DRAWINGS

The following detailed description may be better understood with reference to the accompanying drawings, in which like numerals represent like elements throughout the several figures, briefly described as follows:

FIG. 1 is a functional block diagram generally illustrating a system for creating synthetic user profiles, in accordance with the disclosure.

FIGS. 2A and 2B are a functional block diagrams generally illustrating the creation of a dynamic webpage having internal and external content, in accordance with the disclosure.

FIG. 3 is a sequence diagram generally illustrating the flow of information between components in an online advertising environment, in accordance with this disclosure.

FIG. 4 is a functional block diagram generally illustrating the flow of data between components in an online environment for the creation of dynamic webpages, in accordance with this disclosure.

FIG. 5 is a conceptual diagram generally illustrating the creation of a synthetic user profile using a profile generator, constructed in accordance with this disclosure.

FIG. 6 is a functional block diagram generally illustrating components of a profile monitor constructed in accordance with this disclosure.

FIG. 7 is a logical flow diagram generally illustrating a system for creating synthetic user profiles, in accordance with certain embodiments.

FIG. 8 is a functional block diagram generally illustrating one possible example of a computing device that may be used in various embodiments.

### DETAILED. DESCRIPTION

Generally described, the disclosure is directed to a tool for creating synthetic user profiles. Each synthetic user profile includes user-specific data that approximates the browsing behavior of a particular individual, type of individual, and/or subject demographic. A profile generator simulates visiting a number of actual websites or other online resources based on an estimate of the browsing behavior of the subject demographic. The profile generator accumulates user-specific data and stores it in a particular synthetic user profile for that subject demographic.

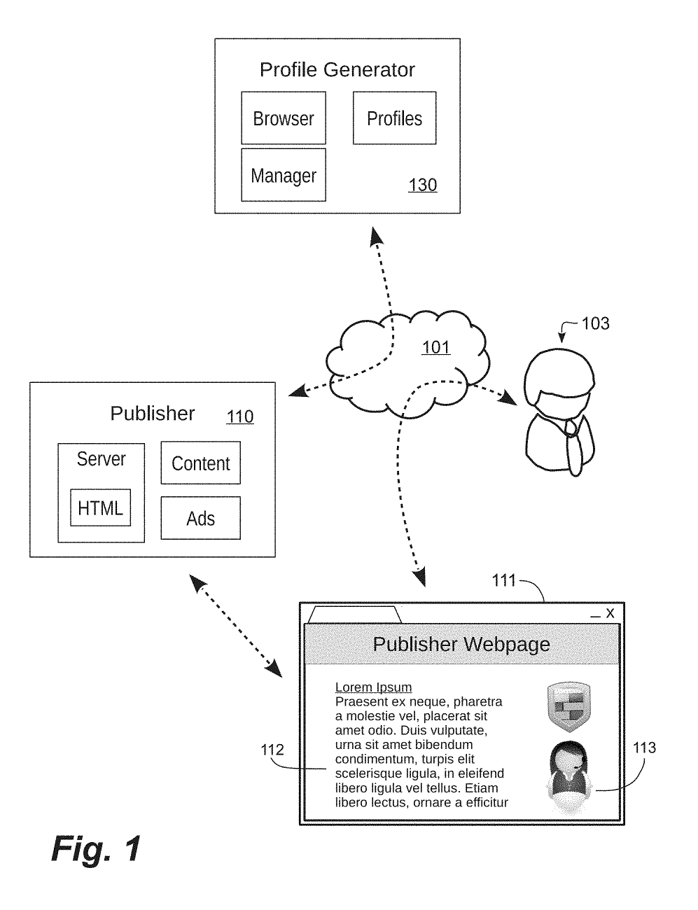

FIG. 1 is a functional block diagram generally illustrating an environment in which operates a profile generator constructed in accordance with the teachings of this disclosure. As illustrated, the environment 100 includes at least one or more publishers (e.g., publisher 110) and a profile generator 130 in communication over a wide area network 101, such as the Internet.

Generally stated, each of the publishers 110 includes a web server for serving content, typically in the form of static or dynamic webpages, constructed using languages such as HTML, PHP, Perl, CGI, ASP, or the like. The publisher 110 may serve up one or more webpages, such as webpage 111. In accordance with implementations of this disclosure, the webpage 111 may include code, such as markup language instructions, that may define both content 112 and ads 113. In one embodiment, the publisher 110 provides (either directly or by a third-party) context-sensitive (targeted) ads 113 to be displayed in conjunction with the content 112 on the publisher's webpage 111.

Appropriate ads 113 may be selected for display on the webpage 111 from a data store of available ads. In one embodiment, particular ads may have associated information that identifies a target audience for each ad. More specifically, data is maintained that associates which type of visitor should receive which types of ads. In other words, a visitor having one particular profile may be more receptive to a particular type of ad, whereas a visitor with a different profile may be more receptive to a different type of ad. Advertising profiles are generally constructed by monitoring the online behavior (e.g., browsing history, search history, purchase history, or the like) of a target demographic.

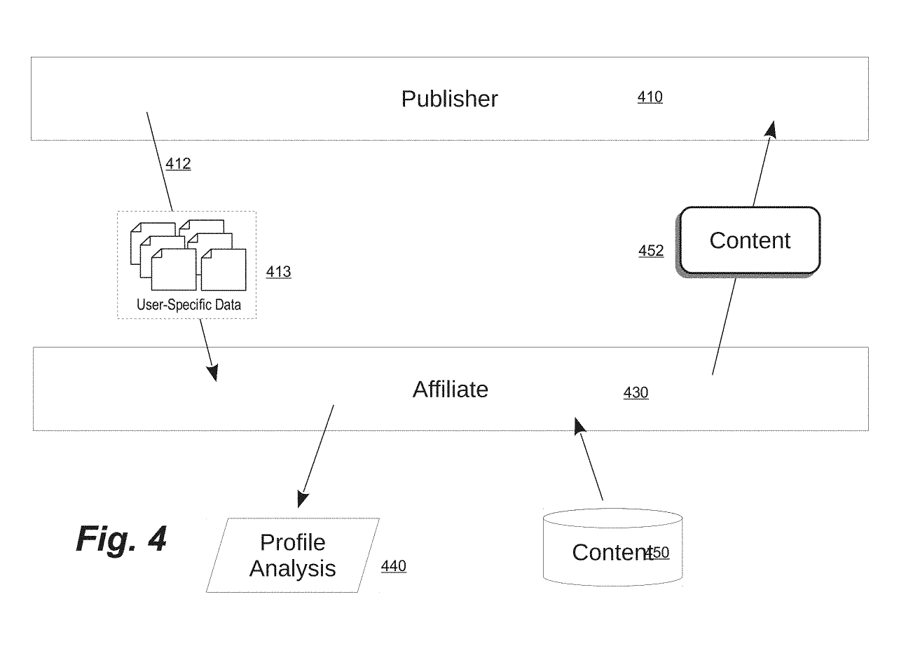

Accordingly, when a particular visitor lands at the web site 111, the publisher 110 serves up the webpage 111 and makes a determination about which ad (e.g., ad 113) to serve in conjunction with the content 112 from a user-specific data stored on the visitor's (e.g., user 103) computing system. One environment for serving content based on a visitor's web browsing history is illustrated in FIGS. 4 and described in detail below. Briefly stated, when the visitor 103 lands on the web site 111, user-specific data is transferred from the visitor 103 to the publisher 110, and the user-specific data is used to select an ad to be served to that visitor 103.

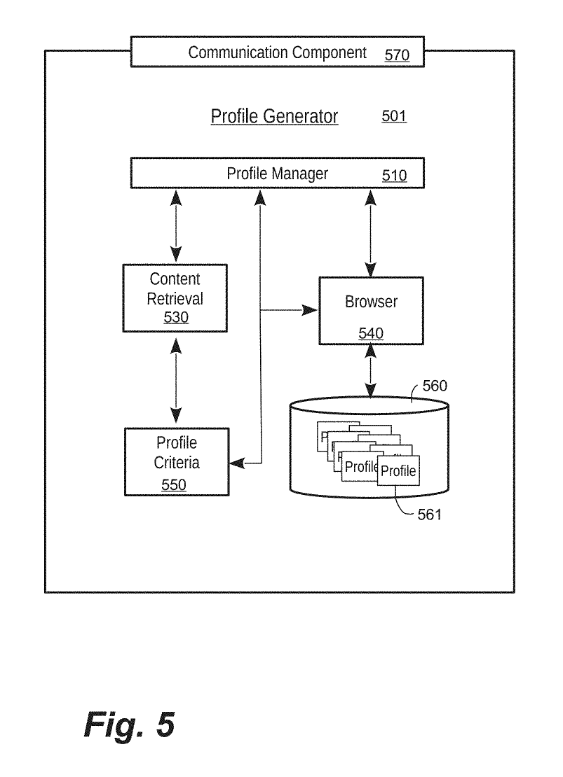

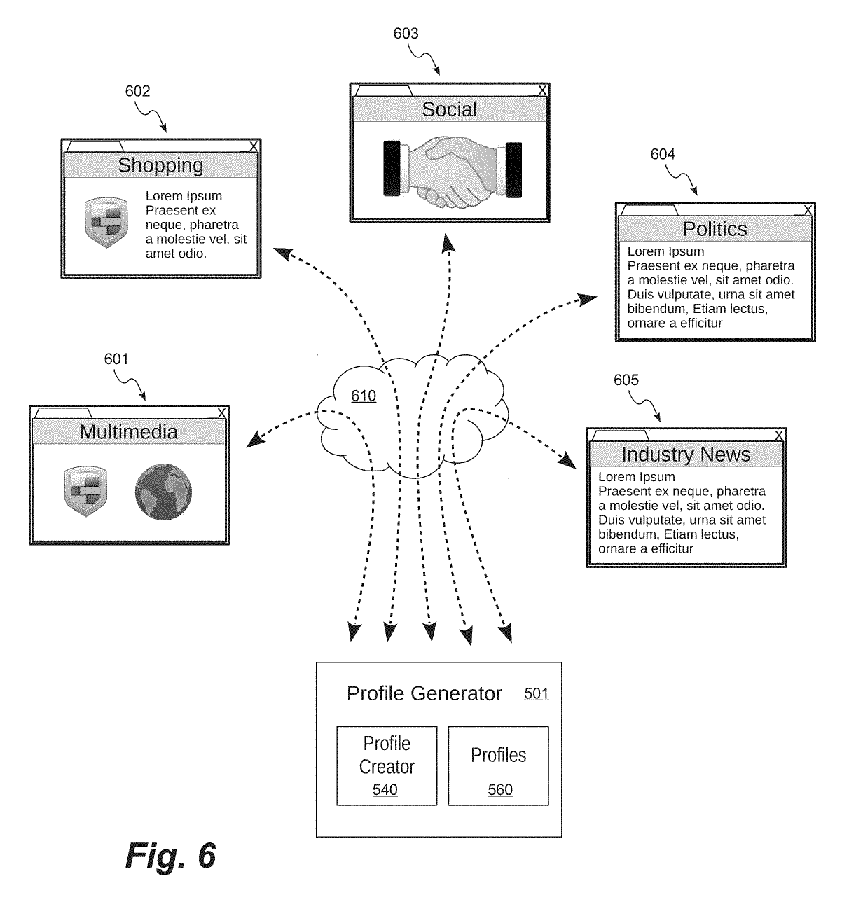

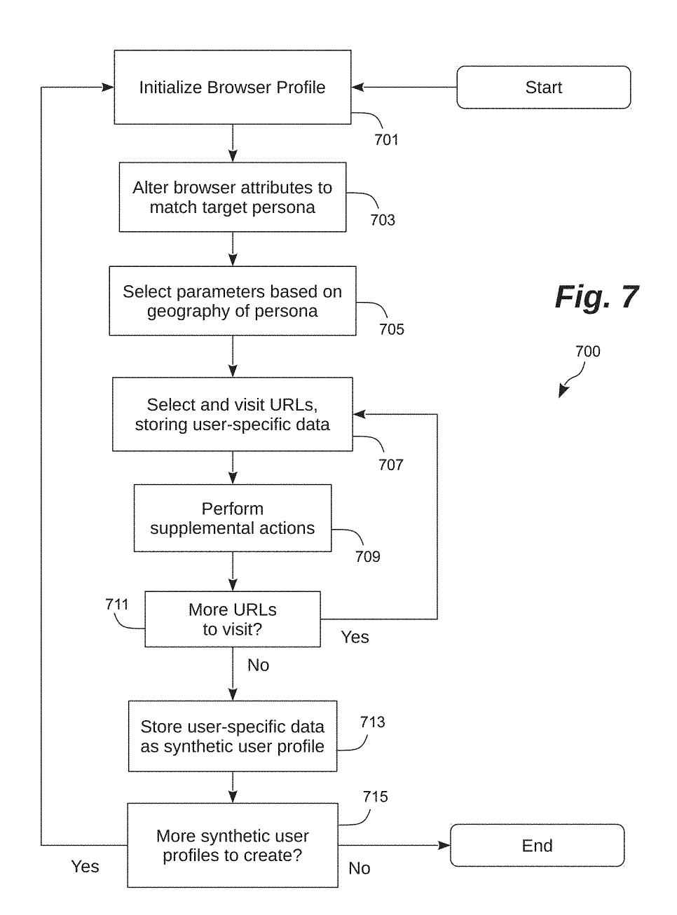

The profile generator 130 is a tool that, generally stated, assembles one or more synthetic user profiles that each include user-specific data that approximates the browsing behavior of a target demographic. One specific implementation of the profile generator 130 is illustrated in FIGS. 5 and 6, and described below. The profile generator 130 includes an management engine that implements a process for creating synthetic user profiles. Particular details of one preferred process are illustrated in FIG. 7 and described below.

Generally stated, the profile generator 130 builds a synthetic-user profile that simulates a member of the publisher's target audience demographic, such as the visitor 103. The profile generator 130 may build the synthetic-user profile by visiting various sites that ordinary members of the target demographic would be expected to visit. The profile generator 130 repeats this process for numerous websites or other resources and accumulates user-specific data until a sufficient amount of user-specific data has been collected to approximate the browsing behavior of a member of the target demographic.

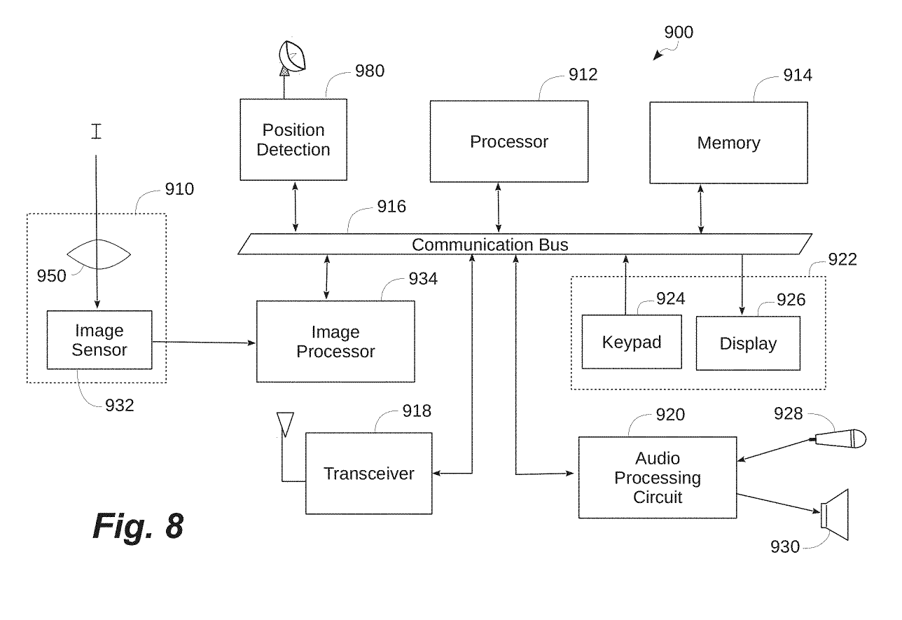

Any one or more of the several entities illustrated in FIG. 1 may communicate over the Internet 101 or other publicly accessible wide area network. Although illustrated in quasi-human form, it should be appreciated that the visitor 103 represents a computing device in use by one or more individuals. The computing device may host user-specific data or information, such as cookies, which represents a profile for the individual or individuals. Finally, the several components illustrated in FIG. 1 may be implemented using computing devices, which are generally known. One illustrative computing device that may be used to implement embodiments is illustrated in FIG. 8 and described below.

The several components illustrated in FIG. 1 implement one preferred embodiment for generating synthetic user profiles. Such an embodiment adds value to web developers by enabling the publisher websites to be more easily tested and/or evaluated in the context of one or more target demographics. What follows now is a discussion of additional detail for specific implementations of several of the components introduced in FIG. 1.

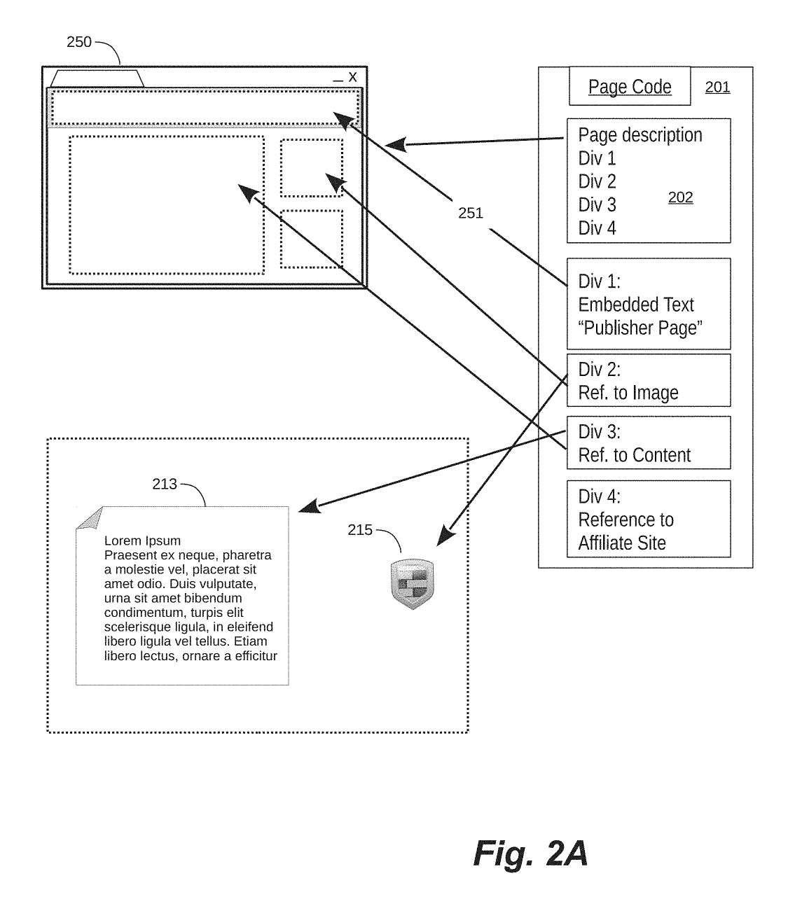

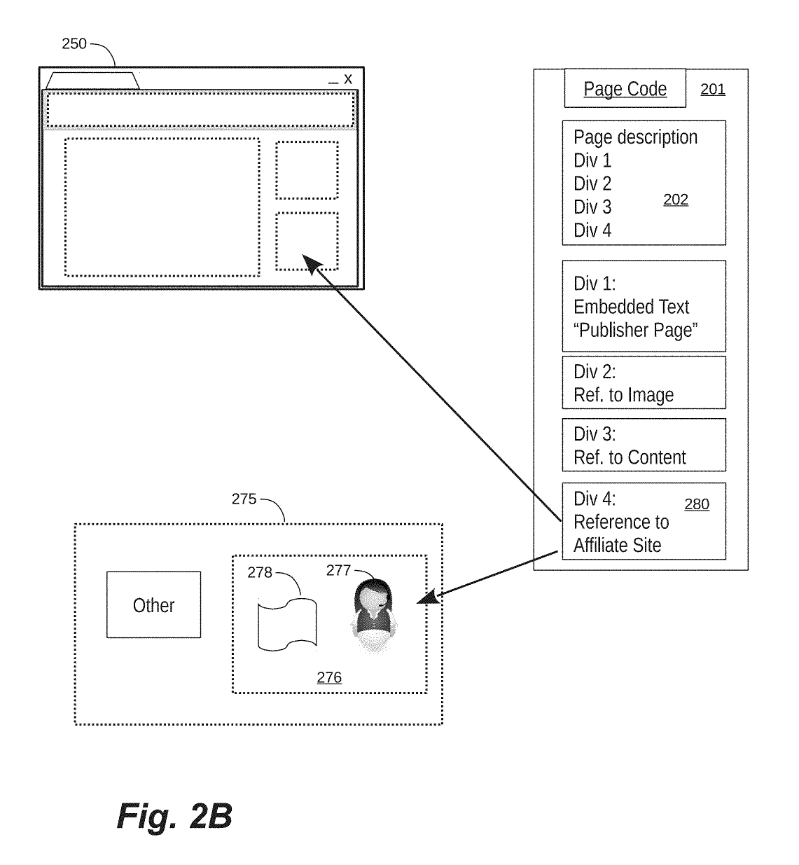

It is helpful to a complete understanding of this disclosure to begin with a general discussion of how dynamic webpages are served by a typical publisher. Turning first to FIG. 2A, a brief discussion of a simple dynamically-generated webpage is provided. To begin, a dynamically-generated webpage (i.e., page 201) includes code, such as markup language or scripts, that describe a webpage. In this simple example, page 201 includes two general types of code. First is code (e.g., HTML, JavaScript, CSS, or the like) that describes what the rendered page 250 should look like in a visitor's browser. In this example, that code is referred to as “page description” code 202. In this example, page description code 202 defines four regions of the rendered webpage 250 in which content should be displayed.

The second type of code (e.g., HTML, PHP, Perl, JavaScript, or the like) defines or identifies content to be delivered for each of the regions defined by the page description code 202. Generally stated, the content may either be defined directly or by reference. For instance, the page code 201 may itself include content, such as text within the page code 201 itself, to be displayed in a particular region of the rendered page 250. In one example, the text “Publisher Page” may be included directly in page code 201 (e.g., in a paragraph tag or inline) which may be rendered in a header region 251 of the rendered page 250.

Alternatively, content may be defined by reference to another source, such as a text file, database, image file, or the like. Generally stated., a reference may be either local or external. A local reference points to content that is within the common control or domain of the web server that is hosting the page code 201. In other words, for the purpose of this discussion, “local content” refers to any content that is under common control with the web server which is hosting the page code 201. In contrast, an “external reference” refers to a target, such as content, that is in a domain different than the local domain. It is important to note that an external reference may point to a target that is in an external domain under the common control of the local domain, but it need not be. In other words, one entity may control multiple domains which each serve content for the rendered page 250, but additional content may be served from another external domain which is not under the control of that entity. By way of example, textual content 213 may be stored in a first domain (e.g., “Publisher.com”) and multimedia content 215 may be stored in a second domain (e.g., “PublisherImages.com”), both of which are controlled by the same entity (e.g., publisher 110). For the purpose of this discussion, both the first domain and the second domain would store “local content.”

Turning now to FIG. 2B, an example of an external reference to content that is not within the common control of the local domain is illustrated. In the illustrated example, an external domain 275 hosts resources 276 which may be referenced (e.g., retrieved for use or invoked programatically) by other entities. The resources 276 may include any one or more of many different content types, such as multimedia content (e.g., ad image 277), code (e.g., script 278) that can be remotely executed, or any other type of resource. The page code 201 includes an external reference 280 that points to some resource 276 of the external domain 275. Accordingly, when the page 201 is requested, each of the several tags and/or references is interpreted and its associated content is returned and displayed as rendered webpage 250 on the requester's browser.

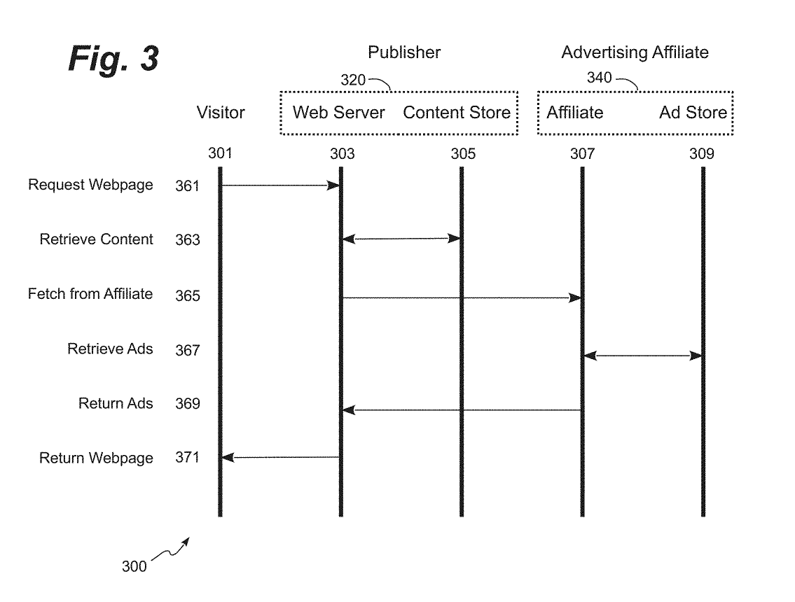

FIG. 3 is a sequence diagram 300 generally illustrating the flow of data between each of several components to accomplish the generation of a dynamic webpage as just described. The sequence begins when a visitor 301 issues a request 361 for a webpage to a web server 303 of a publisher 320. In this embodiment, the web server 303 prepares to respond to the request 361 by initiating assembly of a dynamic webpage. As noted above, the webpage may include requests for both internal content and external content. Accordingly, the web server 305 may retrieve 363 certain content for the webpage from a content store 305. In this example, the content is under the control of the publisher 320. Thus, the publisher 320 maintains its own quality control standards for that content.

In addition, the web server 303 may also fetch 365 additional information, such as advertisements, from an advertising affiliate 340. The web server 303 may issue a request for an ad to the affiliate 307. The request 365 may include profile information (e.g., user-specific data) that helps identify the visitor 301. Specific examples of such profile information is described below in conjunction with FIG. 4. The affiliate 307 in turn retrieves 367 the ad from an ad store 309. The selection of which particular ad to retrieve 367 from the ad store 309 is based, at least partially, on the profile information. Once the ad is selected, it is returned 369 to the web server 303, which in turn incorporates it into the requested webpage and returns 371 the webpage to the visitor 301 for rendering on the visitor's browser.

To complete the discussion, FIG. 4 is a functional block diagram generally illustrating the flow of data between a publisher and an affiliate, in accordance with one embodiment. As illustrated, the publisher 410 may receive a request for a resource (e.g., a webpage) which itself (the requested resource) refers to external content (e.g., an advertisement). In the illustrated example, the requested resource is a webpage that includes a reference to content hosted by an affiliate 430. To service the original request, the publisher 410 issues an ad request 412 and transmits that request to the affiliate 430.

As is known to those skilled in the art, additional information may be transmitted along with the ad request 412. More specifically, certain user-specific data 413 may be transmitted together with the ad request 412. The user-specific data 413 is additional data that helps identify the original requesting entity. Certain specific examples of user-specific data 413 include cookies, web beacons, flash cookies, user-agent strings, referrer headers, information derived from any one or more of the foregoing, or the like. Many more examples will be immediately apparent to those skilled in the art. In short, the user-specific data 413 includes information that helps identify browsing habits or behavior of the requesting individual (or at least the requesting computing system).

The affiliate 430 takes the user-specific data 413 and the ad request 412 and executes a profile analysis 440 to identify a particular ad to return. For instance, the profile analysis 440 may reveal particular browsing habits for the requesting entity or individual which help influence which particular ad from a multiplicity of available ads 450 should he returned. For example, if the user-specific data 413 reveals that the requesting individual had recently been visiting the website of an online shoe store, the profile analysis 440 may suggest that an ad 451 related to shoes is appropriate. In that case, the affiliate 430 would then return ad content 452 to the publisher 410 including the selected ad 451 and perhaps other information, such as updated user-specific data, for example. Alternatively, the ad content 452 could include only the selected ad. 451.

Turning now to FIG. 5, illustrated is one embodiment of an profile generator 501 which may be used in various implementations of this disclosure. The preferred embodiment of the profile generator 501 includes a profile manager 510, a communication component 570, a browser 540, and a plurality of synthetic-user profiles 560. The communication component 570 may be any component that facilitates communication between disparate computing devices, such as over a local or wide area network, or the like. In one example, the communication component 570 enables communication between the profile generator 501 and a remote content provider using, for example, the HTTP, HTTP/2, or any HTTP-like communication protocols. A profile manager 510 is configured to facilitate inter-process cooperation and proper operation. The profile manager 510 may also be configured with logic to schedule and marshal various events and tasks among the several components of the profile generator 501. The profile manager 510 of the preferred embodiment may further include administrative control functions.

In this embodiment, the browser 540 is specially configured to retrieve and accumulate user-specific data as synthetic-user profiles. In addition, the browser 540 of this embodiment may be configured to create and manage a plurality of synthetic user profiles 560, such as profile 561. In this embodiment, each profile 560 represents a fabricated browsing history of an imaginary individual. In this embodiment, the browser 540 is configured to simulate the browsing behavior of a real person by performing a multiplicity of activities to simulate an imaginary person performing various activities, such as browsing or searching the Internet. Each of the several synthetic-user profiles may represent the browsing behavior of different types of real people, each of which represents a different target demographic. The profile manager 510 may initialize the browser 540 with one or more cookies (or other persistent data) that contain session or identity data. In one embodiment, the pre-selected set of cookies may contain session data used to signify that a user is logged into a site. In another embodiment, the cookies may contain identifying metadata used by an ad network or exchange.

The profile manager 510 may modify one or more attributes of the browser making the request to simulate attributes of the persona. This may be achieved by methods including, but not limited to modification of the browser software, emulators built into the browser, modification of browser properties via JavaScript, or the like. For example, the HTTP User-Agent header on requests may be modified to simulate browsers other than the selected browser.

The profile manager 510 may select sites to be visited in a number of different ways. For example, profile criteria 550 may identify particular target demographics for desired synthetic user profiles. Particular websites may be selected which align with each particular target demographic and be added to a list of websites to be visited when creating a synthetic user profile for that target demographic. Similarly or alternatively, the profile manager 510 may assemble a user-configured list of domains, a statistically generated list of domains based on demographic or audience data, an expert system with knowledge of categorized domains, a random selection of domains, or a list of top domains for a geography or demographic.

To illustrate the foregoing, and referring briefly to FIG. 6, the profile generator 501 performs a multiplicity of browsing sessions by visiting numerous other websites (e.g., websites 601-605). The browser 540 is configured to access each of the websites using browsing software that accumulates user-specific data from each website. For instance, the browser 540 may visit website 601, which may be a multimedia rich website with lots of content pertaining to entertainment, for example. By visiting website 601, the browser 540 accumulates whatever cookies and other user-specific data may be set by website 601 browser 540 may also visit website 604, which may be a blog site having political content affiliated with a particular political party, for example. Accordingly, the browser 540 accumulates whatever user-specific data may be set by website 604. The browser 540 repeats this behavior for numerous different and varying websites having different and varying characteristics and, thereby, accumulates user-specific data corresponding to a particular browsing history or pattern. The user-specific data accumulated during such browsing session is stored in a specific profile 560.

The browser 540 may repeat the foregoing operations to generate different synthetic-user profiles 560. In one embodiment, the visited websites may be selected via a variety of means, including random sampling of top websites, or targeted based on a particular demographic group. Alternatively or additionally, the visited websites may be selected to simulate the expected browsing behavior of a target demographic. For example, the profile generator 501 may be tasked with creating one user profile simulating the browsing characteristics of a mature individual and another user profile simulating the browsing characteristics of a young adult. In such a scenario, different browsing criteria may be specified to generate different profiles. For instance, a young adult may be more likely to visit a social network website 603 and a multimedia website 601, whereas a mature individual may be more interested in an industry news website 605 and a political blog 604. However, similarities are also likely. For instance, both individuals may also be interested in a shopping website 602. Accordingly, different user profiles 560 may be generated by specifying different browsing patterns which the browser 540 may execute.

The foregoing discussion speaks in terms of performing actual visits to websites in order to build up a profile for an imaginary user. In an alternative embodiment, visits to websites may be simulated, such as by directly retrieving ad resources specifically used for tracking users (known as “user sync” resources), with headers and metadata that simulates a visit to the website. Additional alternative techniques will also become apparent to those skilled in the art.

To illustrate the foregoing principle, and returning to FIG. 5, the content retrieval component 530 may also be configured to retrieve content from specified websites and pages, such as webpage 111 served by publisher 110 (FIG. 1). In this embodiment, the content retrieval component 530 may simulate visits to any one or more webpages for the purpose of further accumulating user-specific data related to the webpage 111. In one example, the content retrieval component 530 may select a target geography, and implement a mechanism to simulate requests coming from that geography. The mechanisms may include physical server location, IP address, network topology, and emulated GPS or other geolocation data.

Although it is envisioned that implementations of the preferred embodiment will likely retrieve multiple webpages from a particular website, for simplicity of this discussion, examples will be given in the context of retrieving a single webpage. It should be appreciated that, although described as a single webpage, multiple webpages may be retrieved in like manner.

The profile generator 501 may sample the content provider's website to increase the user-specific data that is retrieved. In the preferred embodiment, sampling may occur by visiting a target website using a web browser that has native profile or measurement tools, or one that has been modified to provide such functionality. To obtain a wider range of samples, the profile generator 501 invokes one or more profiles 560, such as user profile 561, to simulate visiting the content provider's website by an actual user (although synthetically generated). The requested webpage may be dynamically created and returned in the manner described above in conjunction with FIGS. 2A and 2B.

The profile manager 510 may perform additional actions during or after the webpage is loaded. Such may occur for the purpose of triggering certain events, altering measurement values, or otherwise influencing the behavior of the website or other third parties. This may either occur actively (e.g., via code injection) or passively by waiting for expected events to occur. These subsequent actions may further generate or modify user-specific content.

FIG. 7 is a logical flow diagram 700 generally illustrating operations performed by one specific implementation of a preferred embodiment. The several operations shown in FIG. 7 may be implemented using computing devices, such as the illustrative computing device shown in FIG. 8 and described below. It should be appreciated that the several operations shown in FIG. 8 implement the preferred embodiment, and many other operations may additionally be added. Likewise, some of the operations may be combined or even eliminated without departing from the spirit and scope of the disclosure.

To begin, a browser is initialized with an active synthetic user profile (701). The subject synthetic user profile may be empty or blank when initialized, or it may be an existing synthetic user profile retrieved from prior operations. The browser alters certain attributes or settings to match the target demographic (or persona) for the active synthetic user profile (703). In one example, a user-agent string for the browser may altered to simulate browsing with a different version of the browser, a different browser entirely, or even a different operating system. Additional settings may be spoofed as well, such as screen size (or the like) to simulate execution on a mobile device. In addition, the browser may optionally alter or select parameters based on a particular geography associated with the active synthetic user profile (705).

Once the browser has been configured in accordance with the active synthetic user profile, the browser begins selecting and visiting websites or other resources at URLs associated with the active synthetic user profile (707). By virtue of such visits, user-specific data is accumulated by the browser to approximate the browsing behavior of the target demographic of the active synthetic user profile. The browser may also perform supplemental actions at the visited web site, such as, for example, performing a predetermined or random search at a search engine website. The process 700 iterates (711) until all available resources have been visited by the browser or, potentially, a timeout period has been reached. Once that occurs, the user-specific data is stored in conjunction with the active synthetic profile (713). The process 700 may also repeat if more synthetic user profiles are to be created, such as for additional target demographics, or the like (715). Alternatively, the process 700 may be executed only once. Many other alternatives are equally possible regarding the repeated execution of the process 700. In addition, it should be appreciated that the process illustrated in FIG. 7 is but one preferred embodiment, and many other implementations of this disclosure will become apparent, to those skilled in the art.

With the synthetic user profile(s) created, a number of previously-unavailable options become available. For instance, the synthetic user profiles may be used, in one embodiment, to retrieve ads from an ad network or ad exchange, which are targeted based on one or more attributes of the synthetic user profile. Additional testing and evaluation may then be done on those ads. Similarly, the synthetic user profiles may be used in conjunction with retrieving and analyzing personalized content from a subject website. The synthetic user profiles are particularly useful in such a case where the subject website provides content that is targeted based on one or more attributes of the synthetic user profile. It should be appreciated that in embodiments that use synthetic user profiles in such a manner, the length of time that has passed since a particular synthetic user profile was created may be a significant factor in its effectiveness. Accordingly, the age of the synthetic user profile should be considered when determining whether to use that synthetic user profile. Likewise, an aged synthetic profile may, in fact, be a desirable characteristic in some circumstances.

FIG. 8 is a functional block diagram generally illustrating one possible example of a computing device 900 that may be used to implement various embodiments. As shown, computing device 900 includes several functional components to enable policing online advertisements. The example computing device may be implemented as one or more of any number of devices, such as a mobile phone, a tablet computer, a personal digital assistant, a notebook or ultrabook computer, a desktop computer, a server computer, a virtual machine, or the like.

The computing device 900 may include a processor 912, a memory 914, communication circuit 916, transceiver 918, audio processing circuit 920, user interface 922, image sensor 932, image processor 934, and optical system 950. Processor 912 controls the operation of the computing device 900 according to programs stored in program memory 914. The communication circuit 916 interfaces the processor 912 with the various other components, such as the user interface 922, transceiver 918, audio processing circuit 920, and image processing circuit 934. User interface 922 may include a keypad 924 and a display 926. Keypad 924 allows the operator to key in alphanumeric characters, enter commands, and select options. The display 926 allows the operator to view output data, such as entered information, output of the computing device 900, images or other media, and other service information. In certain computing devices, the user interface 922 combines the keybad 924 and the display 926 into a touchpad display.

The computing device 900 may also include a microphone 928 and speaker 930 though certain computing devices may not have such features. Microphone 928 converts sounds into electrical audio signals, and speaker 930 converts audio signals into audible sound. Audio processing circuit 920 provides basic analog output signals to the speaker 930 and accepts analog audio inputs from the microphone 928. Transceiver 918 is coupled to an antenna 936 for receiving and transmitting signals on a suitable communications network (not shown).

Image sensor 932 captures images formed by light impacting on the surface of the image sensor 932. The image sensor 932 may be any conventional image sensor 932, such as a charge-coupled device (CCD) or complementary metal oxide semiconductor (CMOS) image sensor. Additionally, the image sensor 932 may be embodied in the form of a modular camera assembly with or without an integrated optical system 950. Image processor 934 processes raw image data collected by the image sensor 932 for subsequent output to the display 926, storage in memory 914, or for transmission by the transceiver 918. The image processor 934 is a signal microprocessor programmed to process image data, which is well known in the art. A position sensor 980 detects the position of the computing device 900 and generates a position signal that is input to the microprocessor 912. The position sensor 980 may be a Global Positioning System sensor, potentiometer, or other measuring device known in the art of electronics.

Other embodiments may include combinations and sub-combinations of features described or shown in the several figures, including for example, embodiments that are equivalent to providing or applying a feature in a different order than in a described embodiment, extracting an individual feature from one embodiment and inserting such feature into another embodiment; removing one or more features from an embodiment; or both removing one or more features from an embodiment and adding one or more features extracted from one or more other embodiments, while providing the advantages of the features incorporated in such combinations and sub-combinations. As used in this paragraph, “feature” or “features” can refer to structures and/or functions of an apparatus, article of manufacture or system, and/or the steps, acts, or modalities of a method.

In the foregoing description, numerous details have been set forth in order to provide a sufficient understanding of the described embodiments. In other instances, well-known features have been omitted or simplified to not unnecessarily obscure the description.

A person skilled in the art in view of this description will be able to practice the disclosed invention. The specific embodiments disclosed and illustrated herein are not to be considered in a limiting sense. Indeed, it should be readily apparent to those skilled. In the art that what is described herein may be modified in numerous ways. Such ways can include equivalents to what is described herein. In addition, the invention may be practiced in combination with other systems. The following claims define certain combinations and subcombinations of elements, features, steps, and/or functions, which are regarded as novel and non-obvious. Additional claims for other combinations and subcombinations may be presented in this or a related document.

The invention is:

1. A system for generating synthetic user profiles, comprising:
a profile generator configured to cause browsing software executing on a computing system to construct a synthetic user profile by retrieving resources from a plurality of third-party websites, the resources including at least user-specific content operative to substantially uniquely identify the synthetic user profile, the user-specific content being reflective of browsing behavior.

2. A method for generating synthetic user profiles, comprising:
initializing content retrieval software in accordance with a subject demographic, the subject demographic generally describing characteristics of interest pertaining to desired browsing behavior;
setting one or more characteristics of the content retrieval software to mimic content retrieval software in accordance with the desired browsing behavior;
visiting a plurality of resources with the content retrieval software, the resources being selected as indicative of resources of interest to the subject demographic;
accumulating user-specific data received from at least one of the plurality of resources visited by the content retrieval software; and
storing the accumulated user-specific data in conjunction with a synthetic user profile associated with the subject demographic.

3. The method recited in claim 2, wherein the content retrieval software comprises Internet browsing software.

4. The method recited in claim 2, wherein the plurality of resources comprises a set of Internet websites selected as being potentially of interest to the subject demographic.

5. The method recited in claim 4, wherein the set of Internet websites is predetermined.

6. The method recited in claim 5, wherein the set of Internet websites is predetermined based on an evaluation of prior browsing history for members of the subject demographic.

7. The method recited in claim 4, wherein the set of Internet websites is pseudo-random.
